(19) United States
(12) Patent Application Publication
(10) Pub. No.: US 2008/0299905 A1
(43) Pub. Date: Dec. 4, 2008

(54) SYSTEM WITH INCOMING CALL DISPLAY INDICATION AND THE METHOD FOR USING THE SAME

(75) Inventor: RAVISH KUMAR, TAINAN COUNTY (TW)

Correspondence Address: WPAT, PC;INTELLECTUAL PROPERTY ATTORNEYS, 2030 MAIN STREET, SUITE 1300, IRVINE, CA, 92614, US

(73) Assignee: HIMAX TECHNOLOGIES LIMITED, TAINAN COUNTY (TW)

(21) Appl. No.: 11/754,900

(22) Filed: May 29, 2007

(51) Int. Cl. H04B 7/00; H04M 1/00

(52) U.S. Cl. 455/41.2; 455/556.1

(57) ABSTRACT

A method for noticing an incoming call of a mobile phone includes the step of coupling the mobile phone to a system. Thereafter, a message of the incoming call is sent to the system. Next, the message is transformed into displaying information by the system. Also, the displaying information is shown on the system.

### BACKGROUND OF THE INVENTION

1. Field of the Invention

The present invention relates to a system with an incoming call display indication and the method for using the same, and more particularly to a system having an embedded bluetooth chip.

2. Description of the Related Art

Two of the greatest drivers of growth in the communication and entertainment industries have been mobile phones and television sets. A lot is also happening as far as convergence of communication and entertainment is concerned. People spend more and more time watching TV programs. At the same time, people rely more and more on the mobile phone to communicate with the outside world. A common situation occurs when one lies on a sofa in front of a TV to enjoy a high-tension football game and fails to hear the mobile phone ring, thus missing out on some important calls.

Although some mobile phones possesses the function of call transfer usage models, such as a bluetooth-enabled headset, such kind of device still requires the user to keep the mobile phone in his or her vicinity, or carry it all the time. If the mobile phone is carelessly put in a far-away corner, the user still has a great likelihood of missing the calls.

### SUMMARY OF THE INVENTION

The system with an incoming call display indication according to an embodiment of the present invention includes a signal-processing unit and a display. The signal-processing unit comprises a bluetooth chip, a memory unit and a graphic display unit. The bluetooth chip is configured to receive a bluetooth signal sent by a mobile phone. The memory unit is configured to store bluetooth information carried by the bluetooth signal. The graphic display unit is configured to generate image signals based on the bluetooth information. The display is configured to display images based on the image signals.

The method for using a system with an incoming call display indication according to an embodiment of the present invention comprises the step of establishing a trusted pair between a mobile phone and the system. In addition, a bluetooth signal sent by the mobile phone is received, where the bluetooth signal carries bluetooth information. Furthermore, the bluetooth information is stored in a memory unit. Also, image signals based on the bluetooth information are generated. Images based on the image signals are displayed on the system.

The method for noticing an incoming call of a mobile phone according to an embodiment of the present invention includes the step of coupling the mobile phone to a system. Thereafter, a message of the incoming call is sent to the system. Next, the message is transformed into displaying information by the system. Also, the displaying information is shown on the system.

### BRIEF DESCRIPTION OF THE DRAWINGS

The invention will be described according to the appended drawings in which:

FIG. 1 shows a wireless connection between a mobile phone and the TV in accordance with an embodiment of the present invention; and

FIG. 2 shows an internal structure of the signal-processing unit in accordance with an embodiment of the present invention.

### PREFERRED EMBODIMENT OF THE PRESENT INVENTION

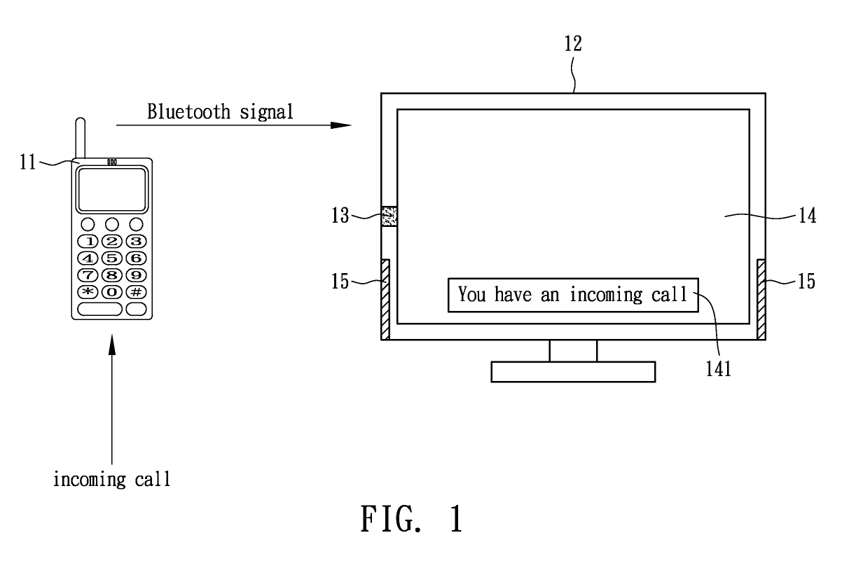

FIG. 1 shows a connection between a mobile phone and a system, such as a TV, according to the embodiment of the present invention. The embodiment of the present invention uses a widely available, short-range, cost-effective wireless bluetooth technology to transmit signals between the mobile phone 11 and the TV 12. The TV 12 in the embodiment of the present invention has a bluetooth chip embedded therein. As far as the mobile phones are concerned, some existing profiles like file-transfer profile or headset-profile can be reused, and they are commonly available on all bluetooth-enabled mobile phones. The users need not buy a separate or new mobile phone to work with the bluetooth-enabled TV in the embodiment of the present invention. When receiving an incoming call, the mobile phone 11 sends bluetooth signals to the TV 12. In other words, the mobile phone 11 initiates a trusted pair between the mobile phone 11 and the TV 12. Once paired, the TV 12 is wirelessly connected to the mobile phone. In the event of an incoming call, an indication about the same can be sent to the bluetooth-enabled TV 12. The signal-processing unit 13 of the TV 12 transforms the bluetooth signal into bluetooth information, and thus stores the bluetooth information therein. There is a region 141 which shows the incoming call display indication on the display 14 of the TV 12. Therefore, even if the speaker 15 of the TV 12 is at its loudest when a user is enjoying a high-tension football game or if the mobile phone is tucked in a far-away corner, the user will not miss any important incoming calls.

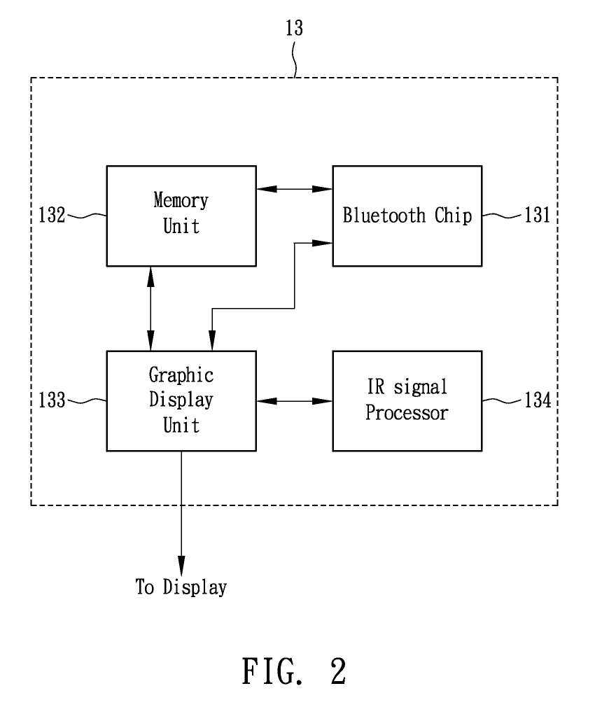

FIG. 2 shows an internal structure of the signal-processing unit according to an embodiment of the present invention. The signal-processing unit 13 of the present invention includes a bluetooth chip 131, a memory unit 132, a graphic display unit 133 and an IR signal processor 134. The bluetooth chip 131 receives the bluetooth signals, in which some bluetooth information is carried, from the mobile phone 11. The bluetooth information, such as a phone number, a message, a photo, a time stamp, a video clip, an audio segment and any combination thereof, is then stored in the memory unit 132. The user can use a remote controller to change the display pattern of the incoming call indication. When the remote controller emits an IR signal, the IR signal processor 134 receives the signals and informs the graphic display unit 133 of that selection from the user. The graphic display unit 133 will retrieve the display info from the memory unit 132 and generate display images according to the user's instruction. The display images can be something as simple as a line of text, such as “You have an incoming call.” Thereafter, the display images are sent to the display 14.

The method for using a television with an incoming call display indication according to an embodiment of the present invention is to establish a trusted pair between a mobile phone 11 and the television 12 first. The bluetooth-enabled mobile phone 11 and the bluetooth-enabled TV 12 have to identify each other and make a connection in the first step. In some circumstances, the bluetooth-enabled TV 12 can emit a bluetooth signal to search for the bluetooth-enabled mobile phone 11. In step 2, the indication of an incoming call is sent to the paired TV 12 through bluetooth signals, in which bluetooth information is carried. In step 3, the bluetooth information is stored in the memory unit inside the bluetooth-enabled TV 12. In step 4, image signals based on the bluetooth information are generated. The user can choose or adjust the image signals which he or she wants by sending control signals from a remote controller. In step 5, the image signals or incoming call indication are/is displayed on the TV 12. If the incoming call is not being taken immediately, the display 14 of the TV 12 will regularly display the incoming call indication. If the incoming call has been taken or called back, the bluetooth information can be erased from the memory unit 132.

The present invention seeks to integrate mobile phones with a new-generation system, such as a digital TV, computer or projector by embedding a bluetooth chip therein. The present invention does not require any special profiles or usage model as far as the user's existing bluetooth-enabled mobile phone is concerned. The users need not buy a separate or new mobile phone to work with the bluetooth-enabled TV of the present invention. The object of the present invention is to show incoming call indications on a TV, which tells the user enjoying a TV program of the incoming call.

The above-described embodiments of the present invention are intended to be illustrative only. Numerous alternative embodiments may be devised by persons skilled in the art without departing from the scope of the following claims.

What is claimed is:

1. A system with an incoming call display indication, comprising:
a signal-processing unit comprising:
a bluetooth chip configured to receive a bluetooth signal sent by a mobile phone;
a memory unit configured to store bluetooth information carried by the bluetooth signal; and
a graphic display unit configured to generate image signals based on the bluetooth information; and
a display configured to display images based on the image signals.

2. The system with an incoming call display indication of claim 1, wherein the signal-processing unit further comprises an Infrared (IR) signal processor that receives an IR signal from a remote controller and controls a display pattern of the images.

3. The system with an incoming call display indication of claim 1, wherein the bluetooth information comprises a phone number, a message, a photo, a time stamp, a video clip, an audio segment and any combination thereof.

4. The system with an incoming call display indication of claim 3, wherein the contents of the bluetooth information are shown on the display.

5. The system with an incoming call display indication of claim 1, wherein the mobile phone initiates a trusted pair between the mobile phone and the system.

6. A method for using a system with an incoming call display indication, comprising the steps of:
establishing a trusted pair between a mobile phone and the system;
receiving a bluetooth signal sent by the mobile phone, wherein the bluetooth signal carries bluetooth information;
storing bluetooth information in a memory unit;
generating image signals based on the bluetooth information; and
displaying images based on the image signals.

7. The method of claim 6, further comprising the step of:
adjusting a display pattern of the images according to an IR signal from a remote controller.

8. The method of claim 6, wherein the step of establishing the trusted pair is initiated by the mobile phone.

9. The method of claim 6, wherein the bluetooth information comprises a phone number, a message, a photo, a time stamp, a video clip, an audio segment and the combination thereof.

10. A method for noticing an incoming call of a mobile phone, comprising the steps of:
coupling the mobile phone to a system;
sending a message of the incoming call to the system;
transforming the message into displaying information by the system; and
showing the displaying information on the system.

11. The method of claim 10, wherein the system is TV, computer or projector.

12. The method of claim 10, wherein the mobile phone sends the message by using a bluetooth module and the system receives the message by using an embedded bluetooth module.

13. The method of claim 10, wherein after the system receives the message, the displaying information is stored in a memory unit.

14. The method of claim 10, wherein the message is transformed into the displaying information by a graphic display unit.

15. The method of claim 10, wherein the displaying information is displayed on the display of the system.

16. The method of claim 10, wherein the system comprises an IR signal processor to receive IR signals from remote controllers for controlling the display of the displaying information.
